(19) United States
(12) Patent Application Publication
(10) Pub. No.: US 2021/0286426 A1
(43) Pub. Date: Sep. 16, 2021

(54) ROTATING MICRO LED DISPLAYS BASED ON EYE MOVEMENTS

(71) Applicant: HEWLETT-PACKARD DEVELOPMENT COMPANY, L.P., SPRING, TX (US)

(72) Inventors: KUAN-TING WU, TAIPEI CITY (TW); CHI HAO CHANG, TAIPEI CITY (TW); YA-LING CHANG, PALO ALTO, CA (US)

(21) Appl. No.: 16/617,905

(22) PCT Filed: Jul. 3, 2017
(86) PCT No.: PCT/US2017/040601

§ 371 Date: Nov. 27, 2019

(51) Int. Cl. G06F 3/01; H01L 25/16; H02P 23/24; G09G 3/32

(52) U.S. Cl. CPC G06F 3/013; H01L 25/167; H01L 25/162; H02P 23/24; G06F 1/1637; G09G 2354/00; G09G 2330/021; G09G 2360/144; G09G 2320/028; G09G 3/32

(57) ABSTRACT

An example micro light-emitting diode (LED) control device includes a substrate, a motor operatively connected to the substrate, a support stand connected to the motor, a support plate on the support stand, and a micro LED on the support plate, wherein the motor is set to rotate the support stand. The motor may rotate the support stand approximately 45° in each lateral direction with respect to a two-dimensional rotation plane. The support stand may include a sub-pixel driving circuit.

### BACKGROUND

For privacy and security purposes some display screens provide field-of-view controls to be visually inaccessible to people sitting next to the user especially in public settings. Micro light-emitting diode (LED) display technology makes use of pixels mounted on each micro LED with the micro LEDs as the pixel light source.

### BRIEF DESCRIPTION OF THE DRAWINGS

FIG. 1 is a schematic diagram illustrating a micro LED control device, according to an example.

FIG. 2 is a schematic diagram illustrating rotation of a micro LED control device, according to an example.

FIG. 3 is a schematic diagram of a micro LED pixel display system, according to an example.

FIG. 4 is a schematic diagram illustrating rotation of a micro LED control device, according to another example.

FIG. 5 is a schematic diagram illustrating independent rotation of the micro LED control devices, according to an example.

FIG. 6 is a schematic diagram of a micro LED pixel display system, according to another example.

FIG. 7 is a flowchart illustrating a method, according to an example.

FIG. 8 is a block diagram of a control system, according to an example herein.

### DETAILED DESCRIPTION

The examples described herein provide a mechanism to detect a user's eyes using iris recognition software and to provide display screen lighting visibility based on the position and movement of the user's eyes. The mechanism uses sensors connected to a micro LED display that are supported by a motor that rotates the support holding the micro LED display. The rotating support allows the screen visibility to be controlled such that the screen is only visible to the user based on the position/angle of the user's eyes. The rotating support structure holding the micro LED display is able to rotate to ensure the user is able to maintain visual connection with the screen even if he/she is angled away from the screen.

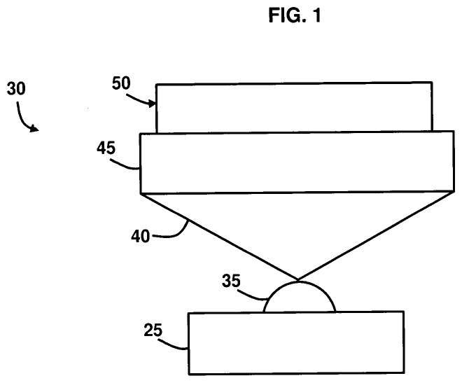

FIG. 1 is a schematic diagram of a micro LED control device 30 comprising a substrate 25, a motor 35 operatively connected to the substrate 25, a support stand 40 connected to the motor 35, a support plate 45 on the support stand 40, and a micro LED 50 on the support plate 45, wherein the motor 35 is set to rotate the support stand 40. The substrate 25 may be rigid or flexible and may comprise any of sapphire, silicon carbide, silicon, and gallium nitride materials, for example. The motor 35 may be a micro electric engine. Examples of micro electric engines include a linear resonant actuator (LRA), a planetary and spur reduction gear motor, a low voltage vibration motor, and a DC motor including brushless motors, among other types of motors.

The support stand 40 is configured as a structural frame, which may comprise conductive material. In one example, the support stand 40 includes amorphous metal alloys. The support stand 40 may be connected to the motor 35 using any suitable mechanism available to structurally connect the support stand 40 to the rotor of the motor 35. The rotor is not shown in the drawings, but would be readily apparent to include the moving part of the motor 35 that drives the rotation of the connected support stand 40. The connection of the support stand 40 to the motor 35 may be a direct connection or an indirect connection utilizing intervening components. The support plate 45 may comprise a conductive material in one example. In another example, the support plate 45 may comprise glass or other type of transparent material such as quartz, plastic, semiconductors, among other types of materials.

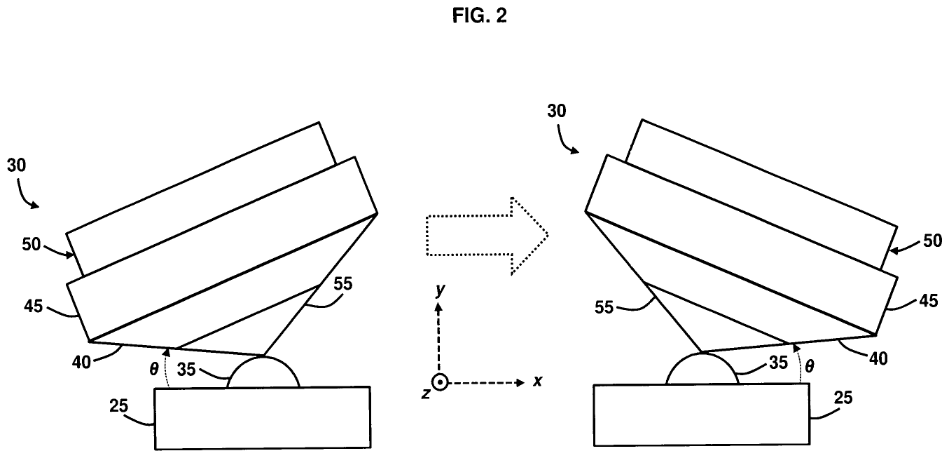

FIG. 2, with reference to FIG. 1, is a schematic diagram illustrating rotation of the micro LED control device 30, according to an example herein.

The illustrations in FIG. 2 depict the rotation of the micro LED control device 30 about a single axis. Using the x-y coordinate plane shown in FIG. 2 as a plane of reference, the micro LED control device 30 rotates in the x-y plane only, which is about the z-axis. The z-axis is transverse to each of the x and y axes. The motor 35 is set to rotate the support stand 40 forty-five degrees (45°) in each lateral direction with respect to the two-dimensional rotation plane x-y. The left side of FIG. 2 shows the micro LED control device 30 rotated to the left of the y axis while the right side of FIG. 2 shows the micro LED control device 30 rotated to the right of the y axis. The motor 35 is controllable with respect to the rotation such that the micro LED control device 30 can rotate at any angle, θ, up to 45° as shown in FIG. 2, and including no rotation, 0°, at all, such as shown in FIG. 1.

The micro LED 50 may comprise a mono or multi-color micro LED 50. The support stand 40 comprises a sub-pixel driving circuit 55. In one example, the sub-pixel driving circuit may comprise electrical control circuitry, which may include, without limitation, digital-to-analog converters, multiplexers, arithmetic circuits, and logic modules that are powered by a voltage source and transmit electrical signals to drive the display action of pixels.

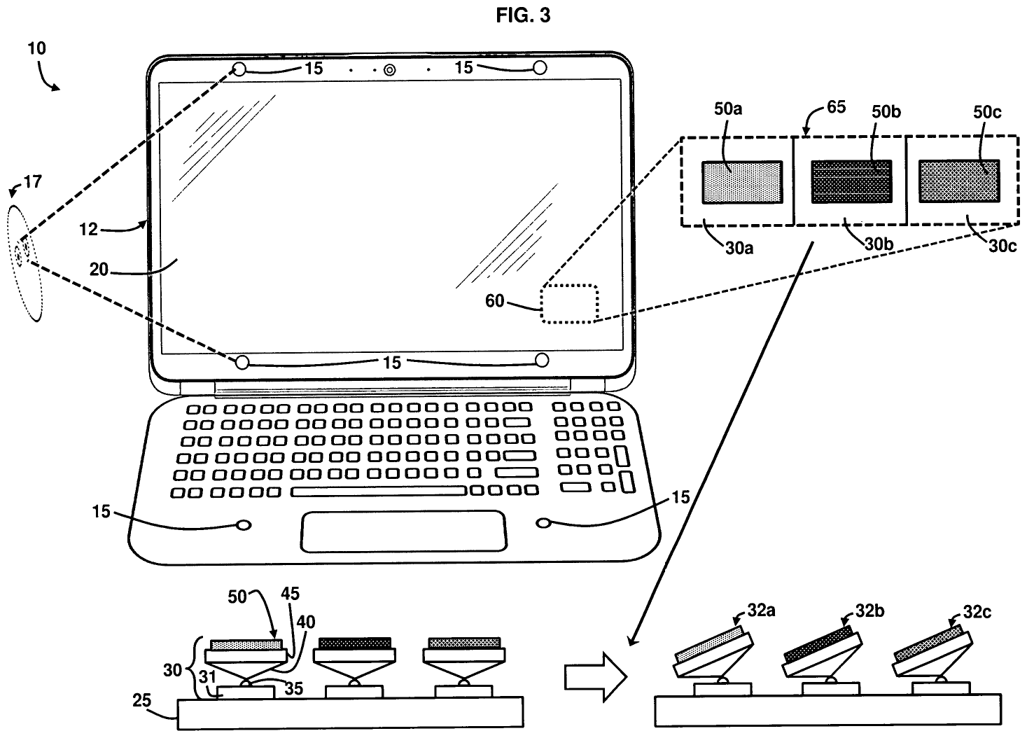

FIG. 3, with reference to FIGS. 1 and 2, is a schematic diagram of a micro LED pixel display system 10, according to an example herein. The micro LED pixel display system 10 comprises a plurality of sensors 15, a display screen 20 adjacent to the plurality of sensors 15, wherein the display screen 20 comprises a substrate 25, and a micro LED control device 30. The plurality of sensors 15 may comprise infrared iris recognition sensors and may be positioned at various locations on an electronic device 12. In various examples, the sensors 15 may be positioned on the front or back of the display screen 20. While the figures depict the electronic device 12 as a laptop computer, the examples herein are not restricted to only a laptop computer. Accordingly, other types of electronic devices having displays may be utilized in accordance with the examples described herein. The substrate 25 may comprise the substrate of the display screen 20, in one example, with the micro LED control device 30 built on and including the substrate 25. In other examples, the substrate 25 may constitute a discrete component separate from the micro LED control device 30.

A support member 31 operatively connects the motor 35 to the substrate 25. In one example, the support member 31 may comprise soldering. The plurality of sensors 15, which may comprise infrared iris recognition sensors, are set to detect eye movements of a user 17. In one example, the plurality of sensors 15 scan the eyes of the user 17 and uses mathematical pattern-recognition software, either stored locally on the electronic device 12 or remotely delivered to the electronic device 12 using firmware, to identify the eye patterns, shapes, color, etc. of the user 17. Once the plurality of sensors 15 visually detect the eyes of the user 17, the plurality of sensors 15 deliver a signal, such as an electrical signal, to the sub-pixel driving circuit 55 based on the detected eye movements of the user 17. In this regard, the plurality of sensors 15 not only detect the appearance of the eyes of the user 17, but also detect the movements of the eyes of the user 17. More particularly, when the user 17 moves his/her head at various angles in relation to the electronic device 12, the plurality of sensors 15 detect the corresponding movements of the eyes of the user 17. In one example, if the sensors 15 are finely tuned, then they may detect the eye movements of the user 17 even when the user does not move his/her head and simply moves their eyes. Accordingly, the user 17 does not have to move his/her head at all, and instead the electronic device 12 may be moved in relation to the stationary user 17 upon detecting changes in the position and location of the eyes of the user 17 relative to the electronic device 12. As such, the plurality of sensors 15 similarly attempt to detect the eyes of the user 17.

After the plurality of sensors 15 deliver the signal to the sub-pixel driving circuit 55, then the sub-pixel driving circuit 55 instructs the motor 35 to rotate in a prescribed direction based on the position of the eyes of the user 17 in relation to the display screen 20. More specifically, the sub-pixel driving circuit 55 sends a corresponding signal, such as an electrical signal, to the motor 35 to begin tilting; i.e., rotating, in a specified direction towards the detected position of the eyes of the user 17. For example, if the user 17 is positioned to the left of the display screen 20 of the electronic device 12, then the sensors 15, in addition to detecting the eyes of the user 17, also detect the relative position of the eyes of the user 17 as being to the left of the electronic device 12, and send a corresponding first electrical signal to the sub-pixel driving circuit 55, which in turn sends a corresponding second electrical signal to the motor 35 to begin rotating towards the position of the user 17; i.e., the motor 35 begins rotating to the left. FIG. 3 illustrates an example of the micro LED control device 30 being initially positioned in a straight configuration; i.e. 0° rotation, and then the corresponding rotation of approximately 45° to the left based on the corresponding position of the user 17, who is depicted as being to the left of the electronic device 12.

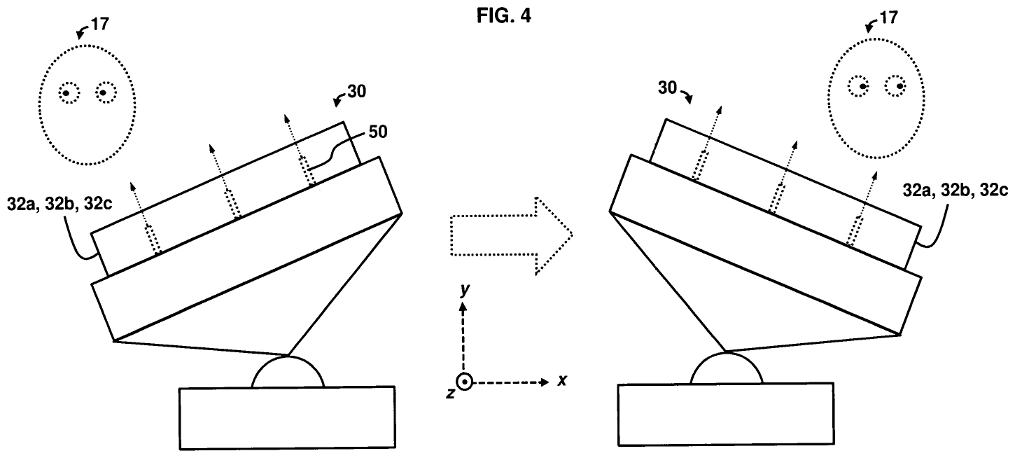

The display screen 20 comprises a pixel area 60 comprising an array 65 of pixels 50a, 50b, 50c, wherein each pixel area 60 of the array 65 of pixels 50a, 50b, 50c comprises a plurality of micro LED control devices 30a, 30b, 30c. The micro LED control devices 30a, 30b, 30c respectively comprise a different color with respect to the light that is transmitted from the particular device 30a, 30b, 30c. In one example, each micro LED control device 30a, 30b, 30c comprises a different translucent colored filter 32a, 32b, 32c respectively corresponding to red (R), green (G), and blue (B) colors such that when light from a micro LED 50, as depicted in FIG. 4, is transmitted through the filter 32a, 32b, 32c, the transmitted light becomes the corresponding color; i.e., red, green, or blue. The micro LED 50 may be positioned below the filter 32a, 32b, 32c, or within the filter 32a, 32b, 32c if the filter 32a, 32b, 32c is configured as a capsule-like mechanism. FIG. 4, with reference to FIGS. 1 through 3, illustrates rotation of the micro LED control device 30 in relation to the movement or position of the eyes of a user 17. The micro LEDs 50 are positioned in the filters 32a, 32b, 32c to transmit light towards the user 17 since the micro LED control device 30 is positioned towards the user 17. In another example, the micro LEDs 50 may comprise different multi-color LEDs such that filters 32a, 32b, 32c may not necessarily be colored in accordance with the red, green, blue configuration. In another example, the micro LEDs 50 are multi-colored and the filters 32a, 32b, 32c are also colored in accordance with the red, green, blue configuration. The various combination of mono/multi-color LEDs 50 with non-colored or colored filters 32a, 32b, 32c controls the overall color that is transmitted from the pixels 50a, 50b, 50c, respectively.

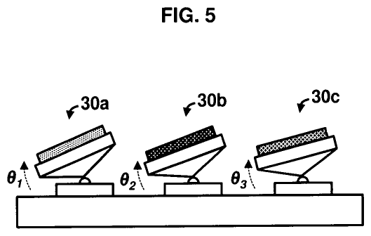

FIG. 5, with reference to FIGS. 1 through 4, illustrates that the plurality of micro LED control devices 30a, 30b, 30c, which comprise a first micro LED control device 30a, a second micro LED control device 30b, and a third micro LED control device 30c, may move independently with respect to one another. For example, the first micro LED control device 30a may be rotated to a first angle θ₁, the first micro LED control device 30a may be rotated to a second angle θ₂, and the first micro LED control device 30a may be rotated to a third angle θ₃ such that the first angle θ₁, second angle θ₂, and third angle θ₃ may be different from one another. In other examples, the plurality of micro LED control devices 30a, 30b, 30c move uniformly with one another; i.e., such that the first angle θ₁, second angle θ₂, and third angle θ₃ are the same.

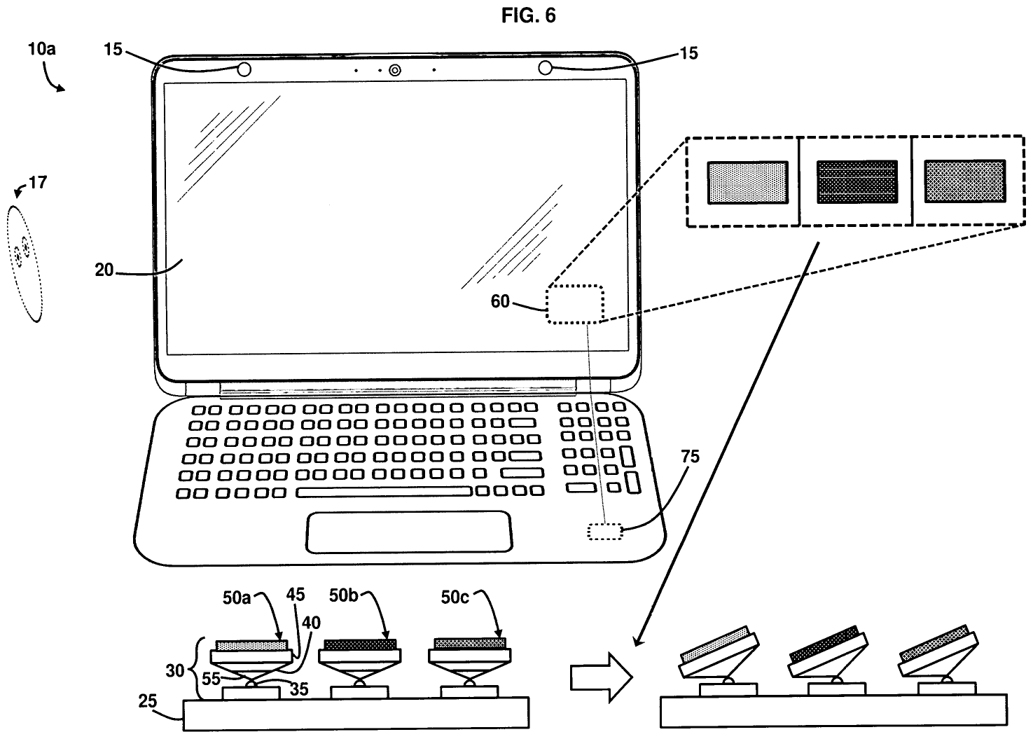

FIG. 6, with reference to FIGS. 1 through 5, is a schematic diagram illustrating a system 10a comprising a plurality of infrared iris recognition sensors 15, an electric circuit 55 set to receive a first set of electrical signals from the plurality of infrared iris recognition sensors 15, a conductive support frame; e.g., support stand, 40 comprising the electric circuit 55, a micro LED pixel 50a, 50b, 50c attached on the conductive support frame 40, and a micro electric engine 35 operatively connected to the electric circuit 55 and conductive support frame 40, wherein the micro electric engine 35 rotates the conductive support frame 40 and the attached micro LED pixel 50a, 50b, 50c upon receiving a second set of electrical signals from the electric circuit 55 based on the first set of electrical signals received from the plurality of infrared iris recognition sensors 15.

The micro electric engine 35 is set to rotate the conductive support frame 40 approximately forty-five degrees (45°) in each lateral direction with respect to a two-dimensional rotation plane x-y. The plurality of infrared iris recognition sensors 15 are set to detect eye movements of a computerized device user 17. The first set of electrical signals comprise encoded data related to directional position of the eyes of the user 17 in relation to the plurality of infrared iris recognition sensors 15. The second set of electrical signals comprise encoded data that corresponds the direction of rotation of the micro electric engine 35 to the directional position of the eyes of the user 17. The system 10 may comprise a power unit 75 set to power off the micro LED 50 upon the plurality of infrared iris recognition sensors 15 failing to detect eyes of a computerized device user 17. System 10a includes all of the features of system 10. However, in system 10a only a pair of infrared iris recognition sensors 15 are provided compared with the plurality of pairs of sensors 15 in FIG. 3. In various examples, the pair of infrared iris recognition sensors 15 may be positioned on the front or back of the screen 20. Moreover, the power unit 75 may also be part of system 10 in one example.

The system 10a may comprise a display screen 20, wherein the plurality of sensors 15 are set to deliver the first set of electrical signals to the electric circuit 55 based on detected eye movements of the user 17, and wherein the electric circuit 55 instructs the micro electric engine 35 to rotate in a prescribed direction based on the position of the eyes of the user 17 in relation to the display screen 20.

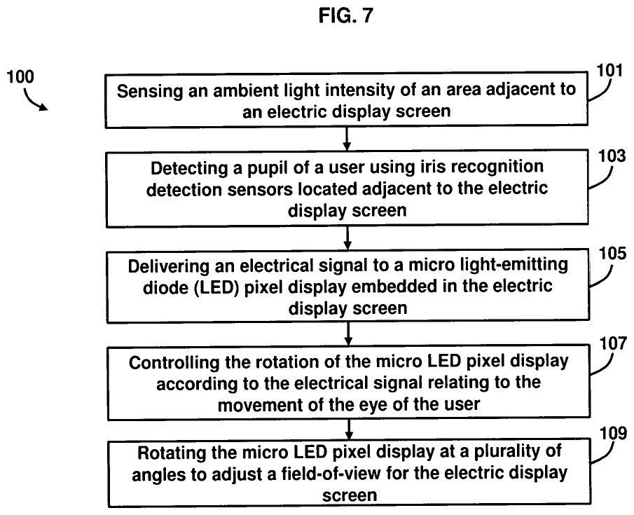

FIG. 7, with reference to FIGS. 1 through 6, is a flowchart illustrating a method 100 comprising sensing an ambient light intensity of an area adjacent to an electric display screen 20 as shown in block 101. Next, in block 103 the method 100 includes detecting a pupil of a user 17 using iris recognition detection sensors 15 located adjacent to the electric display screen 20. Block 105 provides for delivering an electrical signal to a micro LED pixel display 60 embedded in the electric display screen 20, wherein the electrical signal comprises encoded data corresponding to a position of the pupil of the user 17 in relation to the electric display screen 20. Block 107 provides for controlling the rotation of the micro LED pixel display 60 according to the electrical signal relating to the movement of the eye of the user 17, and block 109 shows the method 100 comprising rotating the micro LED pixel display 60 at a plurality of angles to adjust a field-of-view for the electric display screen 20. The method comprises rotating the micro LED pixel display 60 approximately forty-five degrees, 45°, in each lateral direction with respect to a two-dimensional rotation plane x-y. A complete 90° angle of rotation of the micro LED pixel display 60 may occur in approximately one second. For example, with reference to FIG. 4, the micro LED control device 30 may transition from the tilted position shown on the left side of FIG. 4 to the tilted position shown on the right side of FIG. 4 in approximately one second, wherein a complete 90° angle of rotation may occur from the left side image to the right side image in FIG. 4.

By rotating, the micro LED control device 30 is able to transmit light from the LEDs 50 towards the direction of a user 17. In this regard, if a user is positioned to the side of the electronic device 12, then the sensors 15 attempt to search for the eyes of the user 17. Once the sensors 15 make visual contact with the eyes of the user 17, then the corresponding transmission of electrical signals occurs; i.e., from the sensors 15 to the sub-pixel driving circuit 55, and then from the sub-pixel driving circuit 55 to the motor 35 causing rotation of the motor 35 and the corresponding connected support stand 40, support plate 45, and micro LED 50 towards the user 17.

In one example, because the micro LED 50 is angled only in one direction; i.e., towards the user 17, the display screen 20 will appear dark or otherwise having less visual acuity when viewed at an angle not aligned with the user 17. Accordingly, if the user 17 is positioned next to another person and the user 17 moves his/her head to the left or right, then the sensors 15 detect this movement by detecting the movement and position of the eyes of the user 17 and rotate the micro LED control device 30 accordingly. An adjacent person who is positioned next to the user 17 would see a dark screen when attempting to view the display screen 20 because the micro LEDs 50 are not transmitting light in the direction of the adjacent person. In another example, the power unit 75 may power off the micro LED 50 upon the sensors 15 failing to detect eyes of the user 17, after a predetermined period of time. This results in the display screen 20 going dark and thus no data or images on the display screen 20 are viewable at any angle relative to the display screen 20.

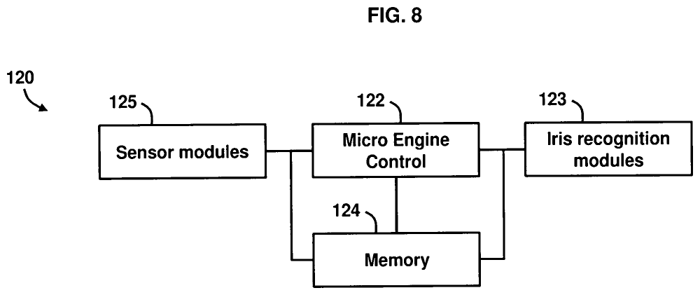

FIG. 8, with reference to FIGS. 1 through 7, illustrates a block diagram of a control system 120 that provides for an automatic screen viewing angle adjustment solution by detecting and recognizing the degree of difference of constricting and dilating responses on the eye pupils of a user 17 through infrared iris recognition and identification sensors 15 and corresponding iris recognition software modules 123 in order to have automatic and real-time micro LED eye-contact control of the display screen 20 based on the user's eye directional movement and position. The micro engine control 122, as enabled by the micro LED control device 30, may combine the data compiled by sensor modules 125, which receive the data provided by sensors 15, with automated biometric identification information stored in memory 124 for a given user 17 to provide user verification for secured access of the electronic device 12 and the contents displayed on the screen 20. Accordingly, the micro engine control 122 provides for enhanced and secured viewing of the display screen 20 as the user 17 reads and operates the screen 20 from different directions. For example, the user 17 may be reading from a book or set of papers and is constantly glancing back-and-forth between the display screen 20 and the set of papers. The micro engine control 122 assesses when the user 17 is actually looking at the screen 20 and adjusts the direction and transmission of the light from the micro LED 50 accordingly. This allows pixels 50a, 50b, 50c to be viewable only at the corresponding angle where the eyes of the user 17 are positioned/aligned with the screen 20. For enhanced information protection and security purposes, the iris recognition modules 123 may be programmed to recognize the eyes of only a particular user 17 that has previously signed-on with the system 10, 10a through a secured credentialed process including password entry and/or facial recognition or other biometric recognition process.

The iris recognition modules 123 and sensor modules 125 may include hardware and software elements to enable the proper pattern matching of the detected eyes of the user 17 with the images of the eyes of the user 17 stored in memory 124. Accordingly, various examples herein can include both hardware and software elements. The examples that are implemented in software include but are not limited to, firmware, resident software, microcode, etc. Other examples may include a computer program product configured to include a pre-configured set of instructions, which when performed, can result in actions as stated in conjunction with the methods described above. In an example, the pre-configured set of instructions can be stored on a tangible non-transitory computer readable medium or a program storage device containing software code.

The present disclosure has been shown and described with reference to the foregoing exemplary implementations. Although specific examples have been illustrated and described herein it is manifestly intended that the scope of the claimed subject matter be limited only by the following claims and equivalents thereof. It is to be understood, however, that other forms, details, and examples may be made without departing from the spirit and scope of the disclosure that is defined in the following claims.

What is claimed is:

1. A micro light-emitting diode (LED) control device comprising:
a substrate;
a motor operatively connected to the substrate;
a support stand connected to the motor;
a support plate on the support stand; and
a micro LED on the support plate,
wherein the motor is set to rotate the support stand.

2. The micro LED control device of claim 1, wherein the motor is set to rotate the support stand approximately 45° in each lateral direction with respect to a two-dimensional rotation plane.

3. The micro LED control device of claim 1, wherein the support stand comprises a sub-pixel driving circuit.

4. A system comprising:
a plurality of infrared iris recognition sensors;
an electric circuit set to receive a first set of electrical signals from the plurality of infrared iris recognition sensors;
a conductive support frame comprising the electric circuit;
a micro light-emitting diode (LED) pixel attached on the conductive support frame; and
a micro electric engine operatively connected to the electric circuit and conductive support frame, wherein the micro electric engine rotates the conductive support frame and the attached micro LED pixel upon receiving a second set of electrical signals from the electric circuit based on the first set of electrical signals received from the plurality of infrared iris recognition sensors.

5. The system of claim 4, wherein the micro electric engine is set to rotate the conductive stand frame approximately 45° in each lateral direction with respect to a two-dimensional rotation plane.

6. The system of claim 5, wherein the plurality of infrared iris recognition sensors are set to detect eye movements of a computerized device user.

7. The system of claim 6, wherein the first set of electrical signals comprise encoded data related to directional position of the eyes of the user in relation to the plurality of infrared iris recognition sensors.

8. The system of claim 7, wherein the second set of electrical signals comprise encoded data that corresponds the direction of rotation of the micro electric engine to the directional position of the eyes of the user.

9. The system of claim 4, comprising a power unit set to power off the micro LED upon the plurality of infrared iris recognition sensors failing to detect eyes of a computerized device user.

10. The system of claim 7, comprising a display screen, wherein the plurality of sensors are set to deliver the first set of electrical signals to the electric circuit based on detected eye movements of the user, and wherein the electric circuit instructs the micro electric engine to rotate in a prescribed direction based on the position of the eyes of the user in relation to the display screen.

11. The system of claim 4, comprising:
a display screen comprising a pixel area; and
a micro LED control device adjacent to the display screen,
wherein the micro LED control device comprises the electric circuit, the conductive support frame, the micro LED pixel, and the micro electric engine,
wherein the pixel area comprises an array of pixels, and
wherein each pixel area comprises a plurality of micro LED control devices.

12. The system of claim 11, wherein the plurality of micro LED control devices comprise a first micro LED control device, a second micro LED control device, and a third micro LED control device, and wherein the first, second, and third micro LED control devices move independently with respect to one another.

13. A method comprising:
sensing an ambient light intensity of an area adjacent to an electric display screen;
detecting a pupil of a user using iris recognition detection sensors located adjacent to the electric display screen;
delivering an electrical signal to a micro light-emitting diode (LED) pixel display embedded in the electric display screen, wherein the electrical signal comprises encoded data corresponding to a position of the pupil of the user in relation to the electric display screen;
controlling the rotation of the micro LED pixel display according to the electrical signal relating to the movement of the eye of the user; and
rotating the micro LED pixel display at a plurality of angles to adjust a field-of-view for the electric display screen.

14. The method of claim 13, comprising rotating the micro LED pixel display 45° in each lateral direction with respect to a two-dimensional rotation plane.

15. The method of claim 14, wherein a complete 90° angle of rotation of the micro LED pixel display occurs in approximately one second.
